(19) United States
(12) Patent Application Publication
(10) Pub. No.: US 2008/0054687 A1
(43) Pub. Date: Mar. 6, 2008

(54) Reclining office chair

(76) Inventor: Cabot Longnecker, Knoxville, TN (US)

Correspondence Address: MCANDREWS HELD & MALLOY, LTD, 500 WEST MADISON STREET, SUITE 3400, CHICAGO, IL, 60661, US

(21) Appl. No.: 11/899,433

(22) Filed: Sep. 5, 2007

Related U.S. Application Data
(60) Provisional application No. 60/842,571, filed on Sep. 5, 2006.
(60) Provisional application No. 60/842,448, filed on Sep. 5, 2006.

(51) Int. Cl. A61G 15/00

(52) U.S. Cl. 297/68

(57) ABSTRACT

A reclining office chair is provided. The reclining office chair includes a swivel base and an extendable foot panel. The extendable foot panel may be extended by a user sitting in the chair my mechanically engaging at least one of the arm rests of the chair.

### RELATED APPLICATIONS

This application claims the benefit of U.S. Provisional Patent Application No. 60/842,571, filed Sep. 5, 2006 and U.S. Provisional Patent Application No. 60/842,448, filed Sep. 5, 2006, both of which are hereby incorporated by reference in their entirety.

### BACKGROUND OF THE INVENTION

The present invention generally relates to a reclinable office chair. More specifically, the present invention relates to an office chair that is reclinable by extending at least one foot panel to support the legs of a user.

Reclinable chairs have been sold to consumers for decades. These chairs, such as La-Z-Boy® brand reclinable chairs, are typically located in the home. Such chairs typically include four solid chair legs and/or rails that support the chair and a large handle mechanism located at the side of the chair in order to initiate the reclining action.

Further, when these chairs recline, the back of the chair typically is moved from a more vertically-oriented position to a more horizontally-oriented position. Further, in some models, a foot panel may rise or be extended to support the legs of the user.

However, despite being sold for decades, reclinable chairs have not had much success in an office environment. The stationary position, low seat height, and reclinable seat back of prior art reclinable chairs are make the typical reclinable chair unsuitable for use in an office environment.

Thus, a need has long been felt for a reclinable chair that is desirable in an office environment.

### BRIEF SUMMARY OF THE INVENTION

One or more of the embodiments of the present invention include an office chair that allows a user to recline by extending an extendable foot panel to support the user's legs. The chair includes a swivel base as found in most office chairs and at least one arm rest. A user sitting in the chair may exert a mechanical force on at least one arm rest ad the mechanical force is coupled by a system inside the chair to exert a mechanical force on the extendable foot panel to raise the extendable foot panel into a position to support the legs of the user of the chair.

### BRIEF DESCRIPTION OF SEVERAL VIEWS OF THE DRAWINGS

FIG. 1 illustrates a reclining office chair according to an embodiment of the present invention.

FIG. 2 illustrates the extendable front foot panel in the extended position.

FIG. 3 illustrates the undercarriage of an alternative embodiment of the reclining office chair.

FIG. 4 illustrates an alternative embodiment of the reclining chair that includes at least one flip-up armrest.

FIG. 5 illustrates a cut-away view of a sleeved spring for use in the seat of the reclining chair.

FIG. 6 illustrates a seat cushioning system including a plurality of sleeved springs.

### DETAILED DESCRIPTION OF THE INVENTION

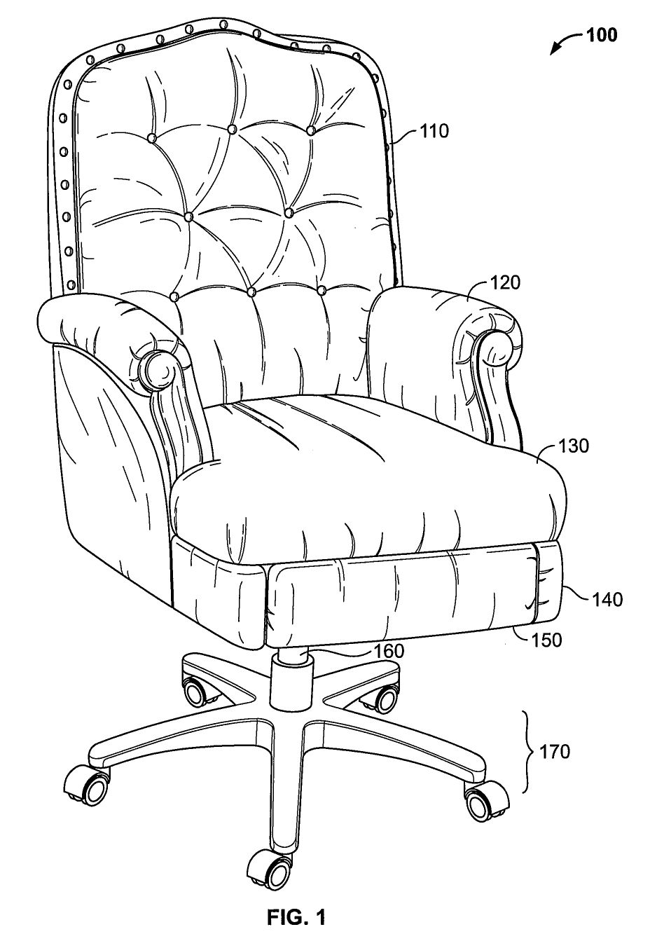

FIG. 1 illustrates a reclining office chair 100 according to an embodiment of the present invention. The reclining office chair 100 includes a chair back 110, a pair of arm rests 120, a seat 130, side foot panels 140, an extendable front foot panel 150, a support post 160, and a swivel base 170.

The swivel base 170 supports the support post 160 which is in turn connected to the chair's internal support structure, as further shown below. The internal support structure in turn is connected to the seat 130, chair back 110, arm rests 120, side foot panels 140, and extendable front foot panel 150.

In operation, a user may sit in the reclining office chair 100 and then push forward on at least one of the pair of arm rests 120. As further described below, the mechanical force generated by the user pushing on at least one of the pair of arm rests 120 engages a reclining mechanism internal to the chair that causes the extendable front foot panel 150 to swing upward from the substantially vertical position shown in FIG. 1 to a more horizontal position suitable for supporting the legs of the user seated in the reclining office chair 100. In this position, the extendable front foot panel 150 is said to be extended.

When the user wishes to retract the extendable front foot panel 150 from the extended position, the user may then pull backward on at least one of the arm rests 120. The mechanical force generated by the user pulling backwards on at least one of the arm rests 120 then engages the reclining mechanism to cause the extendable foot panel 150 to swing downward and resume the substantially vertical position shown in FIG. 1.

Although the embodiment of FIG. 1 illustrates a chair having a pair of armrests, in an alternative embodiment a chair with only a single armrest may be used. Further, the mechanical coupling between the armrests and that causes the extendable foot panel to move may be based on coupling mechanical force introduced on only one of the arm rests or on mechanical force introduced on both of the arm rests. Additionally, although the material covering the chair 100 shown in FIG. 1 is leather-like, any covering such as fabric may be employed and/or one or more parts of the chair 100 may not be covered. Also, although the swivel base as shown in FIG. 1 appears to be made of wood, any rigid material such as metal or plastic may be employed.

Additionally, although the chair 100 of FIG. 1 uses a single extendable foot panel 150 that extends for substantially the width of the front of the chair, the extendable foot panel may be configured in a number of alternative ways. For example the extendable foot panel may extend the entire width of the front of the chair so that the side foot panels do not show from the front of the chair or may wrap around the side of the chair and take the place of some or all of the side foot panels. Alternatively, the front foot panel may have a greater or lesser vertical or horizontal extent. Also, although FIG. 1 illustrates a chair with a single, unitary front foot panel, an alternative embodiment includes a plurality of front foot panels, such as one for each leg, for example. Also, when a plurality of foot panels are used, the foot panels may extend for less than the entire front of the chair. For example, when two foot panels are used in a one-for-each-leg configuration, the middle of the front of the chair may include a vertical component that does not extend.

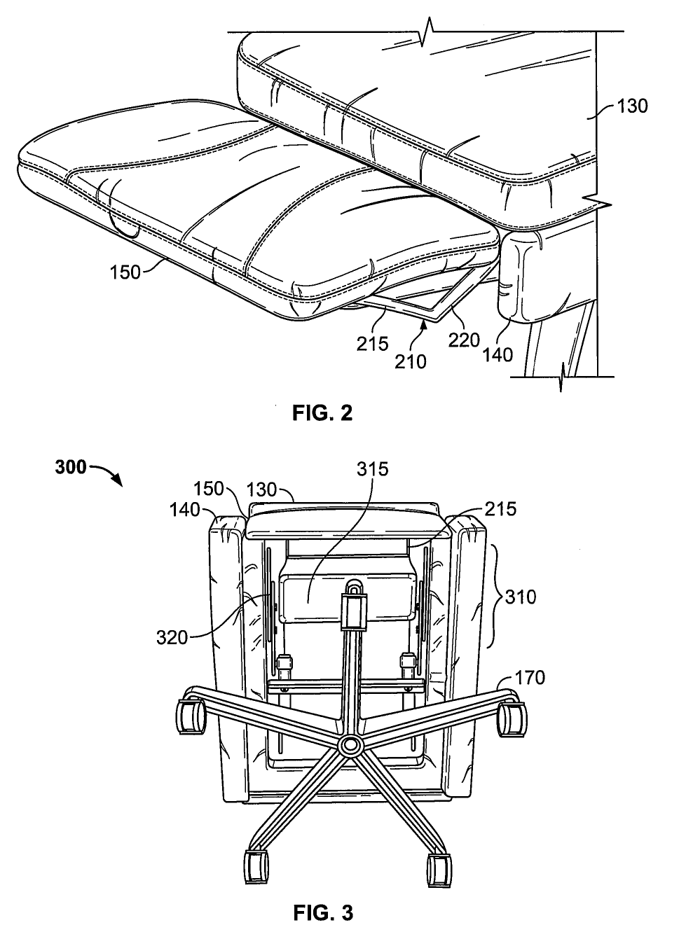

FIG. 2 illustrates the extendable front foot panel 150 in the extended position. Also shown in FIG. 2 are the seat 130 and one of the side foot panels 140, as well as foot panel extender 210. As mentioned above and further described below, the foot panel extender 210 is part of the reclining mechanism that is engaged when the user pushes or pulls on at least one of the arm rests 120.

The foot panel extender 210 includes a first folding element 215 that may be hingedly and/or slidably attached to the back of the extendable foot panel 150. The foot panel extender 210 also includes a second folding element 220 that may be hingedly and/or slidably attached to the first folding element 215. The second folding element is in mechanical cooperation with at least one of the arm rests as described above so that mechanical force exerted on the arm rests causes the first folding element 215 to rotate and/or reposition with regard to the second folding element 220 so as to raise the extendable foot panel 150 into the extended position shown in FIG. 2.

Although one example of an extending mechanism for the extendable foot panel 150 is shown in FIG. 1, a number of alternative mechanisms may be employed such as mechanisms that slid along a track or employ a gear and/or pulley system.

FIG. 3 illustrates the undercarriage of an alternative embodiment of the reclining office chair 300. The chair 300 includes a seat 130, side foot panels 140, extendable foot panel 150, and swivel base 170. Also included are first folding element 215, a mechanical force translation system 310, a supplemental foot panel 315 and a supplemental foot panel extender system 320.

As shown in FIG. 3 and described above, the mechanical force translation system 310 translates mechanical force exerted by a user on at least one of the arm rests 140 into a mechanical force for raising the extendable foot panel 150 into an extended position. More specifically, as shown in FIG. 3 and described above, the mechanical force translation system 310 causes force to be exerted by the first folding element on the extendable foot panel 150 to raise the extendable foot panel 150.

The chair 300 also includes a supplemental foot panel 315 that swings outwardly similar to the extendable foot panel 150 and positions itself proximal to the distal end of the extendable foot panel 150 so as to provide support for a greater length of the user's legs. The supplemental foot panel 315 is also mechanically coupled to the mechanical force translation system 310 so that a user operating at least one of the armrests 140 may cause the supplemental foot panel 315 to extend and retract. More specifically, the mechanical force translation system 310 is mechanically coupled to a supplemental foot panel folding element 320 which is in turn mechanically coupled to the supplemental foot panel 315 so as to allow the supplemental foot panel 315 to be extended and retracted. The supplemental foot panel 315 may alternatively also be known as the extended ottoman.

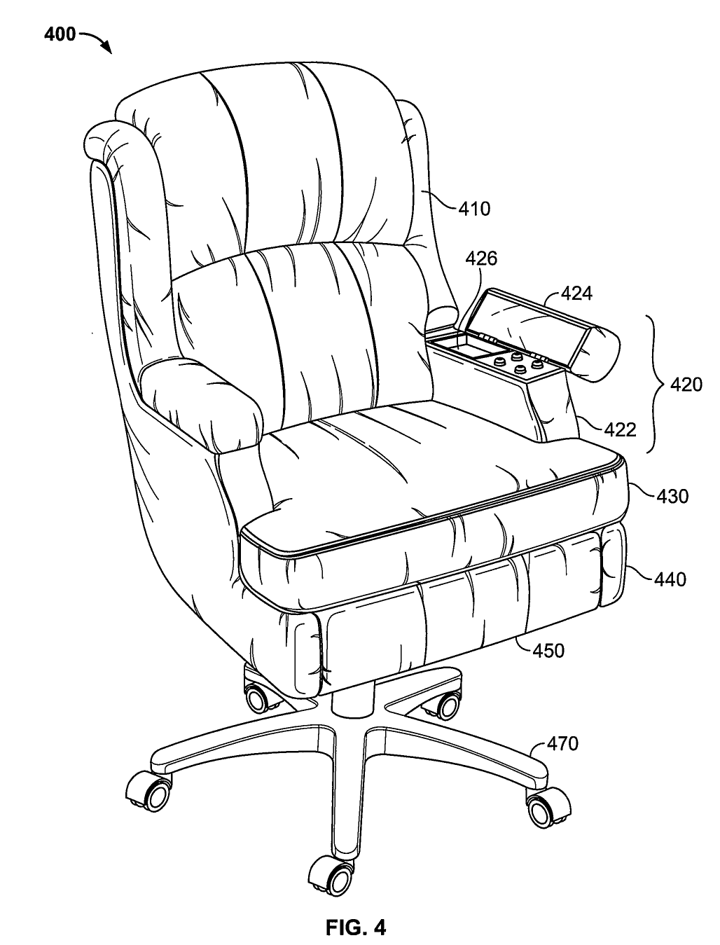

FIG. 4 illustrates an alternative embodiment of the reclining chair 400 that includes at least one flip-up armrest 420. Similar to the embodiment shown in FIG. 1, the alternative chair of FIG. 4 includes a chair back 410, a seat 430, side foot panels 440, an extendable front foot panel 450, and a swivel base 470. However, the alternative chair 400 of FIG. 4 also includes at least one flip-up armrest 420. The flip-up armrest 420 includes a structural support 422, a movable top 424, and at least one compartment 426.

The structural support 422 of the flip-up armrest 420 is attached to the structure of the chair 400. The structural support 422 includes at least one an preferably several compartments 426. The movable top 424 is preferably connected to the structural support 422 using a hinge or other rotating system.

In operation, a user may flip up the movable top 424 of the flip-up armrest 420 as shown in FIG. 4 so as to gain access to the one or more compartments 426 in the structural support 422. The compartments may be sized for holding a variety of objects such as pens, business cards, not pads, cell phones or other telecommunications equipment, soda containers, and other devices or containers for example. The number, shape, and size of the compartments may vary. FIG. 4 illustrates five total compartments comprising one large rectangular compartment, for example for holding a Blackberry or other telecommunications device and four smaller compartments, for holding smaller articles such as pens for example.

One or more of the compartments 426 may also be deep enough so that articles may be placed in the compartment and then the movable top 424 may be flipped down to cover the top of the structural support, hiding the compartment and its contents from view.

Alternatively, both of the arm rests may be equipped to be flip-up. Also, one or more of the arm rests may be flip-up for only a portion of the arm of the chair or may be locking. Also, the arm rest may be formed so that a storage compartment may be accessed without flipping up an arm rest, for example, a small compartment may be positioned in the arm rest near where the arm rest joins the back of the chair, or may be positioned along the vertical rise of the arm rest at the front of the chair.

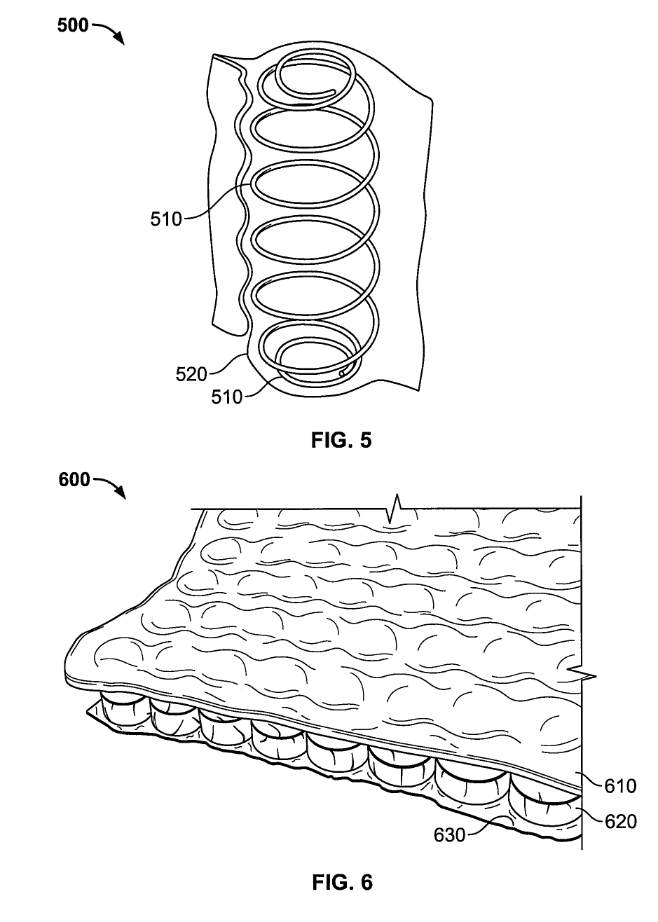

FIG. 5 illustrates a cut-away view of a sleeved spring 500 for use in the seat 130 of the reclining chair 100. As shown in FIG. 5, the sleeved spring 500 includes a number of spring coils 510 and a fabric sleeve 520. As shown in FIG. 5, the fabric sleeve 520 has been cut away so as to better show the spring coils 510 a non-cut away view is shown below.

The sleeved spring 500 is formed by enveloping the spring coils 510 by the fabric sleeve 520. The fabric sleeve 520 is constructed to include many pockets for individual spring coils 510 as shown below.

FIG. 6 illustrates a seat cushioning system 600 including a plurality of sleeved springs 620. Also shown are a top fabric layer 610 and a bottom fabric layer 630. As shown in FIG. 6, the fabric sleeve of the sleeved springs 620 is sewn or otherwise constructed to provide pockets or chambers for individual spring coils. Further, the pockets or chambers are then connected laterally to form a grid of sleeved springs. Finally, the top and bottom of the sleeved springs 620 are covered by the top fabric layer 610 and bottom fabric layer 630.

When the seat cushioning system 600 is installed into the chair, the seat cushioning system is positioned in the seat of the chair and is then preferably covered with at least one further layer of fabric. The seat cushioning system with sleeved springs thus provides greater comfort, higher quality/longer life, and a higher perceived value.

Although FIGS. 5 and 6 show a specific embodiment of the sleeved springs, a number of alternative embodiments are present. For example, the spring coil may include a greater or lesser number of coils or may have a greater or lesser diameter. Additionally, the wire of the spring coil itself may have a greater or lesser diameter. Further, although the spring coil is shown as narrowing at the top and bottom, the spring coil may alternatively widen or remain the same diameter.

Further, although the fabric layers are shown as positioned above and below the spring coils, one or both of the fabric layers may be removed or additionally fabric layers may be added. Also, although the sleeved springs are shown as positioned in a single grid, a plurality of grids of sleeved springs may be employed.

In other words, the pushback reclining office chair offers a non-handle activated recline feature that is new in office chair design. The concept takes the advantages of the pushback (or push-through-the-arms) high leg recliner and allows the user to merely push on the arms in a backward motion to activate the footstool and extended ottoman to come out and support the legs in a recline position.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A reclining chair including:
a swivel base supporting a chair seat;
an extendable foot panel positioned at the front of said chair seat; and
at least one arm rest mechanically connected to said extendable foot panel to allow a user to mechanically engage said at least one arm rest to extend said extendable foot panel.

2. The reclining chair of claim 1 further including a supplemental foot panel that is mechanically connected to said at least one arm rest.

3. The reclining chair of claim 2 wherein said supplemental foot panel extends to a position proximal to a distal end of said extendable foot panel to provide additional support of the legs of a user of said chair.

4. The reclining chair of claim 1 further including at least one flip-up armrest.

5. The reclining chair of claim 4 wherein said flip-up arm rest includes at least one compartment located in said arm rest.

6. The reclining chair of claim 4 further including a plurality of flip-up armrests.

7. The reclining chair of claim 1 wherein said chair seat includes at least one sleeved spring.

8. The reclining chair of claim 1 wherein said chair seat includes at least one spring wherein said spring is enclosed in fabric to separate said spring from another spring.

9. A method for reclining a chair including:
supporting a chair seat with a swivel base;
positioning an extendable foot panel at the front of said chair seat;
mechanically connecting at least one arm rest to said extendable foot panel; and
mechanically engaging said at least one arm rest to extend said extendable foot panel.

10. The method of claim 9 further including mechanically connecting a supplemental foot panel to said at least one arm rest.

11. The method of claim 10 further including extending said supplemental foot panel a position proximal to a distal end of said extendable foot panel to provide additional support of the legs of a user of said chair.

12. The method of claim 9 wherein said chair includes at least one flip-up armrest.

13. The method of claim 12 wherein said flip-up arm rest includes at least one compartment located in said arm rest.

14. The method of claim 12 wherein said chair includes a plurality of flip-up armrests.

15. The method of claim 9 wherein said chair seat includes at least one sleeved spring.

16. The method of claim 9 wherein said chair seat includes at least one spring wherein said spring is enclosed in fabric to separate said spring from another spring.
